(19) United States
(12) Patent Application Publication
(10) Pub. No.: US 2007/0121873 A1
(43) Pub. Date: May 31, 2007

(54) Methods, systems, and products for managing communications

(76) Inventors: Jennifer P. Medlin, Atlanta, GA (US); Robert A. Koch, Norcross, GA (US)

Correspondence Address: SCOTT P. ZIMMERMAN, PLLC, PO BOX 3822, CARY, NC, 27519, US

(21) Appl. No.: 11/282,545

(22) Filed: Nov. 18, 2005

(51) Int. Cl. H04M 3/42

(52) U.S. Cl. 379/210.01

(57) ABSTRACT

Methods, systems, and products are disclosed for managing communications. One such method receives a communication from a sender. The communication is queued in a queue. Prior to removing the communication from the queue, the sender is provided with identifying information of a recipient to whom the communication will be communicated.

### NOTICE OF COPYRIGHT PROTECTION

A portion of this disclosure and its figures contain material subject to copyright protection. The copyright owner has no objection to the facsimile reproduction by anyone of the patent document or the patent disclosure, but otherwise reserves all copyrights whatsoever.

### BACKGROUND

This application generally relates to communications and, more particularly, to special services for queuing of communications and for diversion of communications.

Automatic call distribution systems are known. When a customer calls a business, the customer is commonly placed in a holding queue by the automatic call distribution system. Because an idle attendant is unproductive and inefficient, there is a high likelihood that the customer will hold in a queue until an attendant becomes available. As the customer waits in the queue, the automatic call distribution system plays music or announcements. The customer may even hear an estimated wait time before an attendant is available.

These known distribution systems, however, can be improved. Because the wait times can be long, the customer often has little knowledge of their progress through the queue. After several minutes many customers become frustrated and hang up. Those customers that remain holding understandably want to be productive, so they “multi-task.” That is, as the customer waits in the queue, the customer enables the speakerphone and undertakes other tasks. When an agent or attendant suddenly appears, the customer scrambles to pick up their phone and to gather their thoughts. What is needed, however, are advancements that improve the customer's hold experience.

### SUMMARY

The aforementioned problems, and other problems, are reduced, according to the exemplary embodiments, using methods, systems, and products that manage communications. The exemplary embodiments describe a queuing software application that queues communications in a queue. This queuing application, however, provides features that improve the wait experience. For example, before a customer begins speaking with the next-available attendant, the exemplary embodiments provide an alert. This alert notifies the customer that she is about to be connected to the next-available attendant. The alert may be provided seconds or minutes prior, thus allowing the customer to return to the phone, to gather their thoughts, or to otherwise prepare. The alert may even include the name of the next-available attendant. Another feature of the alert allows the customer to continue holding in the queue. When the holding customer becomes engrossed in another activity, the customer may not be immediately prepared to speak with the next-available attendant. The exemplary embodiments, however, permit the customer to continue holding, and the customer may even specify how much longer they wish to hold. The exemplary embodiments, then, improve the customer's hold experience by providing notice of an imminent connection to the next-available attendant and by providing an option to continue waiting.

The exemplary embodiments include methods, systems, and products for managing communications. A communication is received from a sender. When no recipient is available to receive the communication, the communication is queued in a queue. Prior to removing the communication from the queue, the sender is provided with identifying information of a recipient to whom the communication will be communicated. The term “communication” is used to generically describe any form of communication. The exemplary embodiments, for example, may be applied to any electronic messages (e.g., email, text message, page, or fax), telephone calls, Voice-Over Internet Protocol calls, instant messages, or to any other form. The terms “sender” and “recipient,” then, are used to generically describe the parties to such communications.

In another of the embodiments, a system manages communications placed in a holding queue. The system includes a queuing application stored in memory, and a processor communicates with the memory. The processor receives a communication from a sender and queues the communication in the queue. Prior to removing the communication from the queue, the processor provides the sender with identifying information of a recipient to whom the communication will be communicated.

In yet another embodiment, a computer program product manages communications. The computer program product comprises a computer-readable medium and a queuing application stored on the computer-readable medium. The queuing application comprises computer code for receiving a communication from a sender and queuing the communication in a queue. Prior to removing the communication from the queue, the processor provides the sender with identifying information of a recipient to whom the communication will be communicated.

Other systems, methods, and/or computer program products according to the exemplary embodiments will be or become apparent to one with ordinary skill in the art upon review of the following drawings and detailed description. It is intended that all such additional systems, methods, and/or computer program products be included within this description, be within the scope of the claims, and be protected by the accompanying claims.

### BRIEF DESCRIPTION OF THE SEVERAL VIEWS OF THE DRAWINGS

These and other features, aspects, and advantages of the exemplary embodiments are better understood when the following Detailed Description is read with reference to the accompanying drawings, wherein:

FIG. 1 is a simplified schematic illustrating a queuing application, according to exemplary embodiments;

FIG. 2 is a more detailed schematic illustrating the queuing application, according to exemplary embodiments;

FIGS. 3-5 are additional detailed schematics illustrating the queuing application, according to more exemplary embodiments;

FIGS. 6 and 7 are schematics illustrating a swapping procedure, according to exemplary embodiments;

FIGS. 8 and 9 are schematics illustrating another swapping procedure, according to more exemplary embodiments;

FIG. 10 is a schematic illustrating the queuing application operating within an Automatic Call Distribution (ACD) system, according to still more exemplary embodiments;

FIG. 11 is a block diagram showing the queuing application residing in a computer system, according to exemplary embodiments;

FIG. 12 is a flowchart illustrating a method of managing communications, according to exemplary embodiments; and

FIG. 13 is another flowchart illustrating a method of managing communications, according to even more exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

The exemplary embodiments describe a queuing software application that queues communications in a queue. This queuing application, however, provides features that improve the wait experience. For example, before a customer begins speaking with the next-available attendant, the exemplary embodiments provide an alert. This alert notifies the customer that she is about to be connected to the next-available attendant. The alert may be provided seconds or minutes prior, thus allowing the customer to return to the phone, to gather their thoughts, or to otherwise prepare. The alert may even include the name of the next-available attendant. Another feature of the alert allows the customer to continue holding in the queue. When the holding customer becomes engrossed in another activity, the customer may not be immediately prepared to speak with the next-available attendant. The exemplary embodiments, however, permit the customer to continue holding, and the customer may even specify how much longer they wish to hold. The exemplary embodiments, then, improve the customer's hold experience by providing notice of an imminent connection to the next-available attendant and by providing an option to continue waiting.

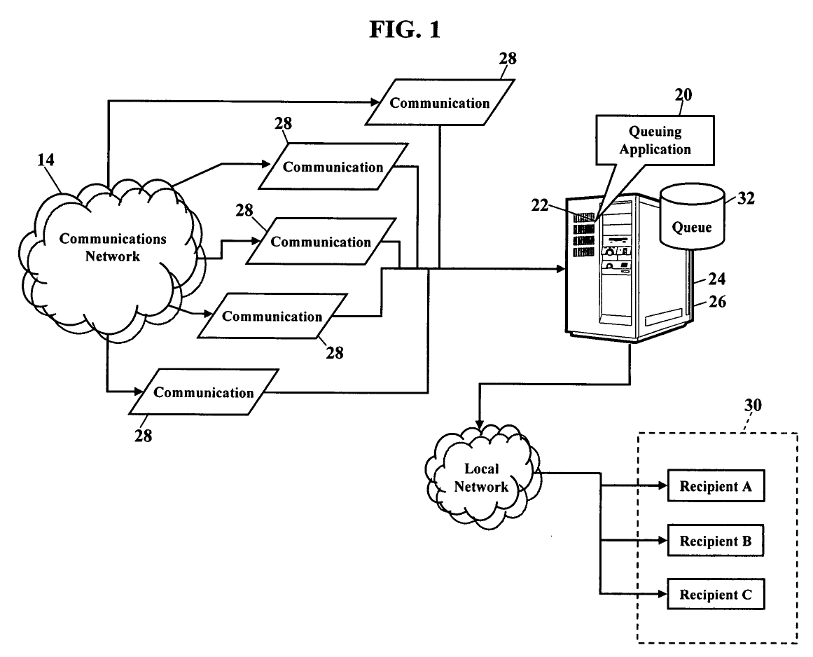

FIG. 1 is a simplified schematic illustrating a queuing application 20, according to exemplary embodiments. The queuing application 20 is a set of processor-executable instructions that are stored in memory 22 of a communications device 24. Although the communications device 24 is shown as a computer server 26, the communications device 24, as will be later explained, may be any processor-controlled device. Whatever the communications device 24, the queuing application 20 processes, manages, and/or allocates incoming communications 28 amongst one or more recipients 30. That is, as communications 28 are received, the queuing application 20 receives those communications and assigns a recipient 30 to each communication. When the number of incoming communications exceeds the number of available recipients, the queuing application 20 queues the communications in a queue 32. As a recipient 30 becomes available, the queuing application 20 removes a waiting or holding communication from the queue 32 and assigns that communication to the now-available recipient. The incoming communications 28 sequence through the queue 32 as recipients become available. Those of ordinary skill in the art will appreciate that there are many known implementations for a queue. Thus, the description of the operation of the queue 32 is omitted here for the sake of brevity. If, however, the reader desires more information, the reader is directed to the following sources, with all these sources incorporated herein by reference in their entirety: U.S. Pat. No. 4,788,715 to Lee; U.S. Pat. No. 5,867,572 to MacDonald et al.; U.S. Pat. No. 6,064,730 to Ginsberg; U.S. Pat. No. 6,122,346 to Grossman; U.S. Pat. No. 6,690,776 to Raasch; U.S. Pat. No. 6,714,643 to Gargeya et al.; U.S. Pat. No. 6,738,473 to Burg et al.; U.S. Pat. No. 6,798,877 to Johnson et al.; U.S. Pat. No. 6,801,620 to Smith et al.; U.S. Pat. No. 6,820,260 to Flockhart et al.; Published U.S. Patent Application 2001/0024497 to Campbell et al.; Published U.S. Patent Application 2003/0112952 to Brown et al.; and Published U.S. Patent Application 2005/0008141 to Kortum et al.

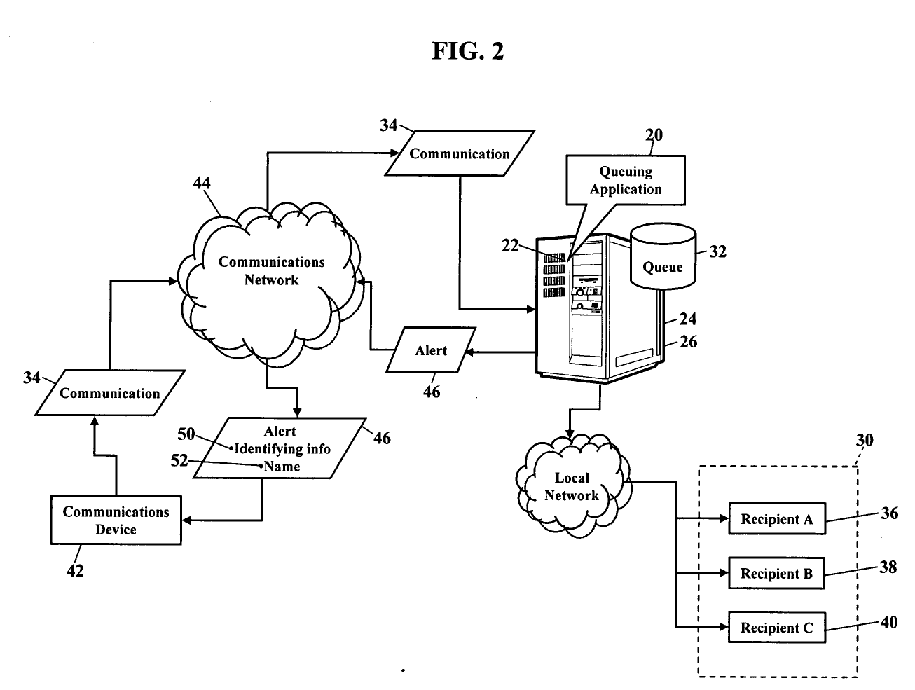

FIG. 2 is a more detailed schematic illustrating the queuing application 20, according to exemplary embodiments. The queuing application 20 queues an incoming communication 34. The incoming communication 34 may have any form, such as an electronic message (e.g., email, text message, page, or fax), a telephone call, a Voice-Over Internet Protocol call, an instant message, or any other communication. The queuing application 20 processes, manages, and/or allocates the incoming communication 34 amongst the recipients 30. Although there may be any number of recipients, FIG. 2, for simplicity, illustrates three (3) recipients “A,” “B,” and “C” (shown respectively, as reference numerals 36, 38, and 40). The recipients 36, 38, and 40 may be collocated (such as at a customer service center or call center), or the recipients may be remotely or diversely located. The physical location of the recipients, in fact, is unimportant, and the exemplary embodiments may be applied regardless of the physical location of any recipient. The communication 34 communicates from a sender's communications device 42 via a communications network 44. The communications network 44 may have any structure, such as a cable network operating in the radio-frequency domain and/or the Internet Protocol (IP) domain. The communications network 44, however, may also include a distributed computing network, such as the Internet (sometimes alternatively known as the “World Wide Web”), an intranet, a local-area network (LAN), and/or a wide-area network (WAN). The communications network 44 may include coaxial cables, copper wires, fiber optic lines, and/or hybrid-coaxial lines. The communications network 44 may even include broadband over power line portions and/or wireless portions utilizing any portion of the electromagnetic spectrum and any signaling standard (such as the I.E.E.E. 802 family of standards, GSM/CDMA/TDMA or any cellular standard, and/or the ISM band). The concepts described herein may be applied to any wireless/wireline communications network, regardless of physical componentry, physical configuration, or communications standard(s).

The queuing application 20 queues the incoming communication 34. When none of the recipients 36, 38, and 40 are available to accept or to receive the incoming communication 34, the queuing application 20 places the communication 34 in the queue 32. As any recipient 30 becomes available, the communication 34 sequences in the queue 32. Here, however, before the communication 34 is removed from the queue 32 and assigned to an available recipient, the queuing application 20 return communicates an alert 46 to the sender's communications device 42. The alert 46 communicates from the queuing application 20, operating in the communications device 24 (e.g., the computer server 26), and to the sender's communications device 42. The alert 46 notifies the sender that a recipient is about to become available. In one embodiment the alert 46 includes identifying information 50 for the recipient. The identifying information 50 may include a name 52 of the recipient, such as the recipient's given name, a nickname, or a pseudo name (usually one that is easier to pronounce and preserves anonymity). The alert 46, for example, may be voice message such as “In approximately five seconds you will hear a tone indicating you are about to be connected to John, our customer service representative.” The alert 46 may additionally or alternatively be any electronic message informing the sender 42 of the name 52 of the recipient and/or additional information regarding when the recipient will be connected with the sender.

According to an exemplary embodiment the alert 46 is sent contemporaneously with or sent prior to removing the communication 34 from the queue 32. That is, the alert 46 may be sent at any time before, or just as, the communication 34 is released from “hold” in the queue 32. The alert 46, for example, may be sent minutes, or seconds, before the recipient 30 becomes available. The alert 46, alternatively, may be sent when the communication 34 sequences to a predetermined position within the queue 32. The alert 46, for example, may be sent when the communication 34 advances to a first position in the queue 32, meaning the communication 34 will be assigned to the next-available recipient. The alert 46 may include an estimated wait time until the communication 34 is removed from the queue 32. The alert 46 may also be periodically sent to the sender 42, thus providing a periodic update on progression through the queue 32. Different alerts may indicate progression through the queue 32. A first alert, for example, indicates a wait time and provides information as to what alert will be received when the communication 34 is about to be put through to the recipient 30. A second alert (such as a tone) could then indicate that the communication 34 is about to be put through. The alert 46, then, provides the sender 42 with advance notice of an imminently available recipient, and the alert 46 conveniently provides the name of the recipient and/or additional information.

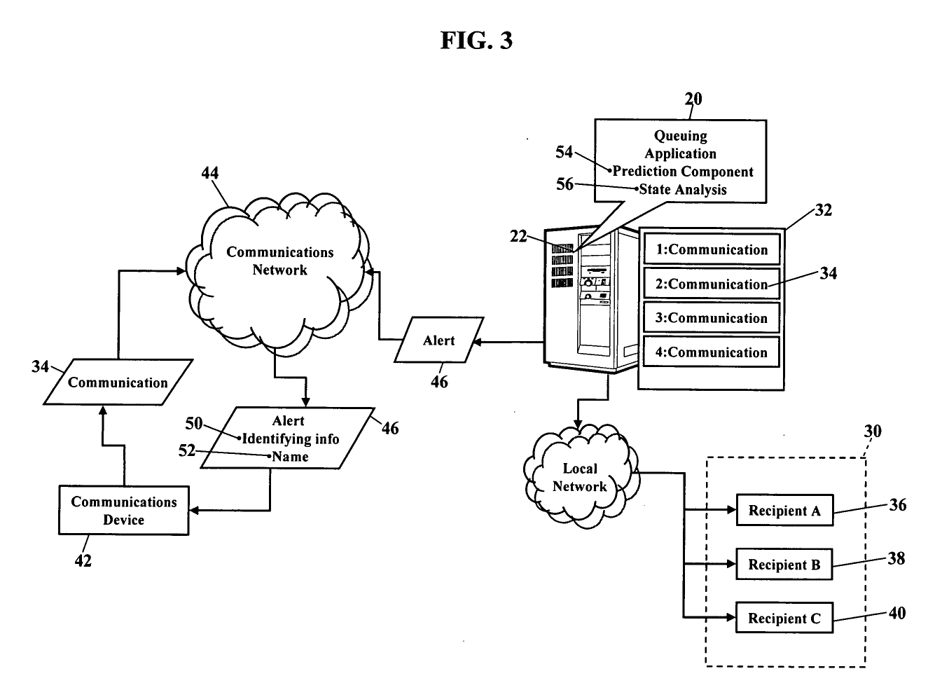

FIG. 3 is another detailed schematic illustrating the queuing application 20, according to more exemplary embodiments. Here the queuing application 20 predicts what recipient will become available to receive the communication 34. The queuing application 20 includes a prediction component 54. This prediction component 54 receives and analyzes measurement statistics and predicts who will be the next-available recipient. The queuing application 20 then sends the alert 46 to the sender's communications device 42. The alert 46 includes the identifying information 50 of the predicted recipient (such as the name 52 of the predicted recipient). The prediction component 54 may use any of many known metrics to predict the next-available recipient. These known metrics include average wait times, positioning in the queue 32, number of communications in the queue 32, and many other metrics. Here, however, the prediction component 54 may additionally or alternatively use state analysis 56. This state analysis 56 predicts that a recipient will become available when that recipient reaches a certain state in handling a communication. That is, suppose a recipient 30 is currently engaged in a communication with a customer. When the recipient 30 reaches a point in that communication where termination is imminent, the prediction component 54 knows that the recipient 30 is about to become available to receive another communication from the queue 32. Perhaps the recipient 30 is executing a closing script, disposing of a call, or sending a reply message. Whatever the procedure, when the recipient 30 reaches a predetermined state, the prediction component 54 knows that the recipient will again become available to accept or receive another communication.

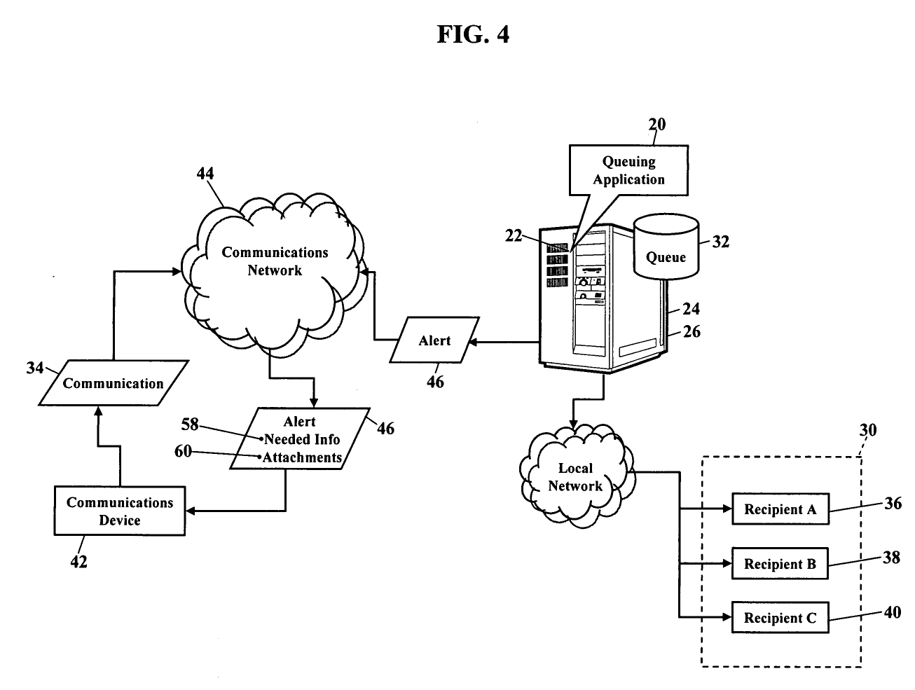

FIG. 4 is a schematic further illustrating the queuing application 20, according to even more exemplary embodiments. Here, when the queuing application 20 sends the alert 46 to the sender's communications device 42, the alert 46 also informs the sender of any information 58 that will be needed by the recipient. The alert 46, for example, may remind the sender to obtain a customer/account number. The sender could also be reminded to obtain forms or data that the recipient will discuss. The alert 46 may additionally or alternatively include an electronic form or a webpage, or even attachments 60. When the sender's communications device 42 receives the alert 46, the sender could complete the form, webpage, or attachment 60 and return communicate the prepared information. When the recipient becomes available, the recipient could immediately access the completed information.

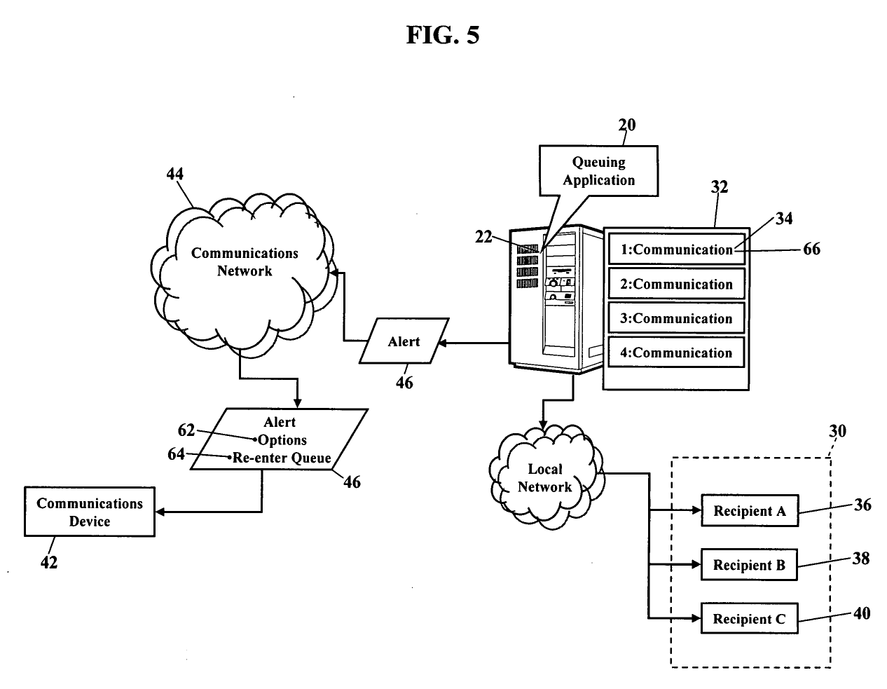

FIG. 5 is a schematic further illustrating the queuing application 20, according to still more exemplary embodiments. Here, when the queuing application 20 sends the alert 46 to the sender's communications device 42, the alert 46 includes one or more options 62. These options 62 allow the sender to control future actions taken by the queuing application 20. The alert 46 may provide a graphical or audible menu of options from which the sender may make selections. When the sender responds to any of the options, the sender asserts some measure of control over the queuing application 20. If the sender declines to respond, then the queuing application 20 continues to sequence the queue 32, and the sender awaits a recipient.

FIG. 5 additionally illustrates one such option. Here the alert 46 includes an option 64 to re-enter the queue 32. That is, even though the communication 34 has advanced in the queue 32, this option 64 allows the sender to re-enter the queue 32 and “buy” more time. As the communication 34 sequences on “hold” in the queue 32, the sender may become engaged in another activity. When the communication 34 sequences to a first position 66 in the queue 32, the sender may be so engrossed in that activity that the sender is not ready to communicate with the next-available recipient 30. The sender, instead, may wish to re-enter the queue 32 at a different position and obtain more hold time. If the sender responds and accepts more hold time, the queuing application 20 may then remove the sender's communication 34 from the first position 66 within the queue 32. The queuing application 20 would then select a new position within the queue, advance the communications ranked above that new position, and then reorder the sender's communication 34 to the new position.

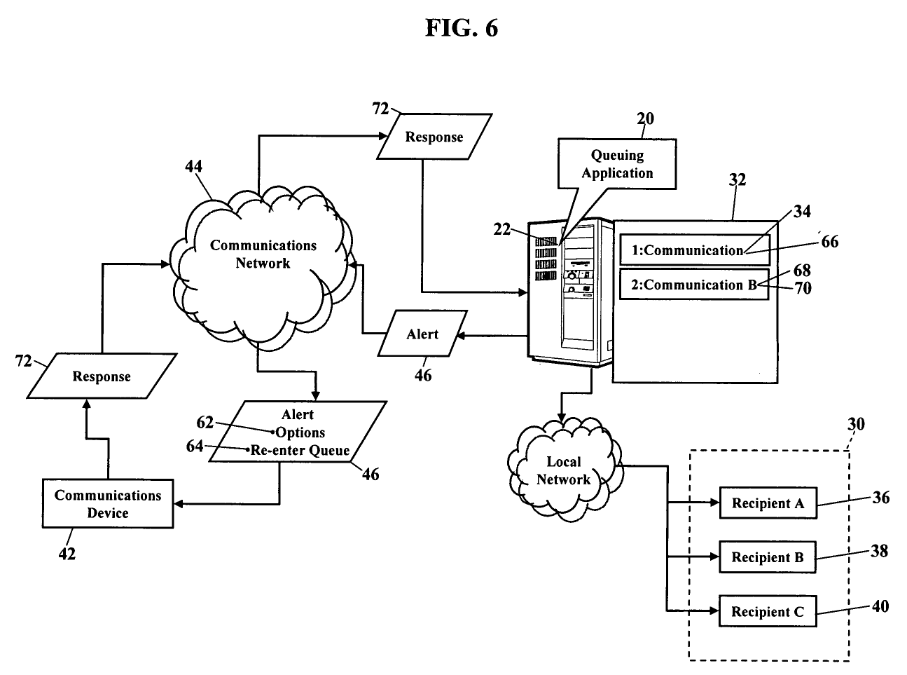

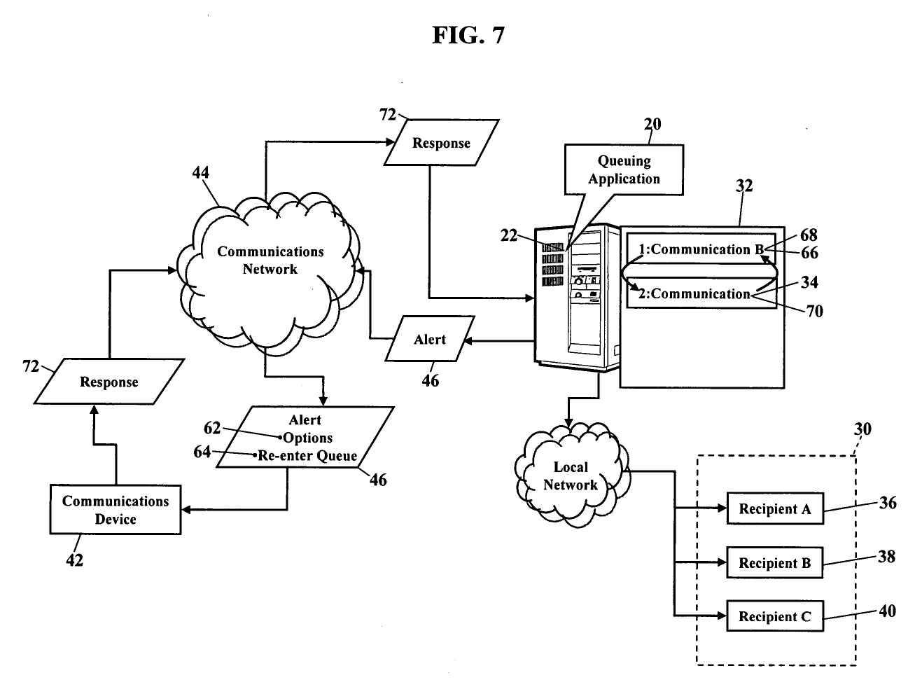

FIGS. 6 and 7 are schematics illustrating a swapping procedure, according to exemplary embodiments. FIG. 6 illustrates the sender's communication 34 occupying the first position 66 within the queue 32. Another communication 68 (graphically illustrated as “Communication B”) occupies a second position 70 within the queue 32. Because the communication 34 has advanced in the queue 32, the queuing application 20 sends the alert 46 prior to removal. The alert 46 includes the option 64 to re-enter the queue 32. When the sender receives the alert 46, the sender may wish to defer and obtain more hold time. The sender's communications device 42 sends a response 72 via the communications network 44, with the response 72 accepting the option. When the queuing application 20 receives the response 72, the queuing application 20 “swaps” communications occupying the first position 66 and the second position 72 within the queue 32. As FIG. 7 then illustrates, although the sender's communication 34 previously advanced to the first position 66, the queuing application 20 removes the sender's communication 34 from the first position 66, advances the another communication 68 (“Communication B”) to the first position 66, and reassigns the second position 70 to the sender's communication 34. The another communication 68 (“Communication B”) now occupies the first position 66, and the sender's communication 34 now occupies the second position 70. The sender has thus re-entered the queue 32 at a different position and obtained more wait/hold time.

The exemplary embodiments may be applied to any communication occupying the first position 66. The queuing application 20, for example, may send the alert 46 to any sender that occupies the first position 66. As each sender's communication advances to the first position 66 in the queue 32, the queuing application 20 provides the name of the next-available recipient (as discussed above). The queuing application 20 may or may not provide each sender the option 64 to re-enter the queue 32 at a different position. In theory, if successive senders each accept the option to re-enter the queue 32, a recipient could be available and, yet, sit idle. An available, but idle, recipient would be an unproductive use of resources. When a recipient is available, the exemplary embodiments, then, may not offer the option 64 to re-enter the queue 32. That is, if a recipient is currently available and ready to receive a communication, the exemplary embodiments may be configured to not offer the option 64. Whatever communication occupies the first position 66 may have to accept a currently-available recipient.

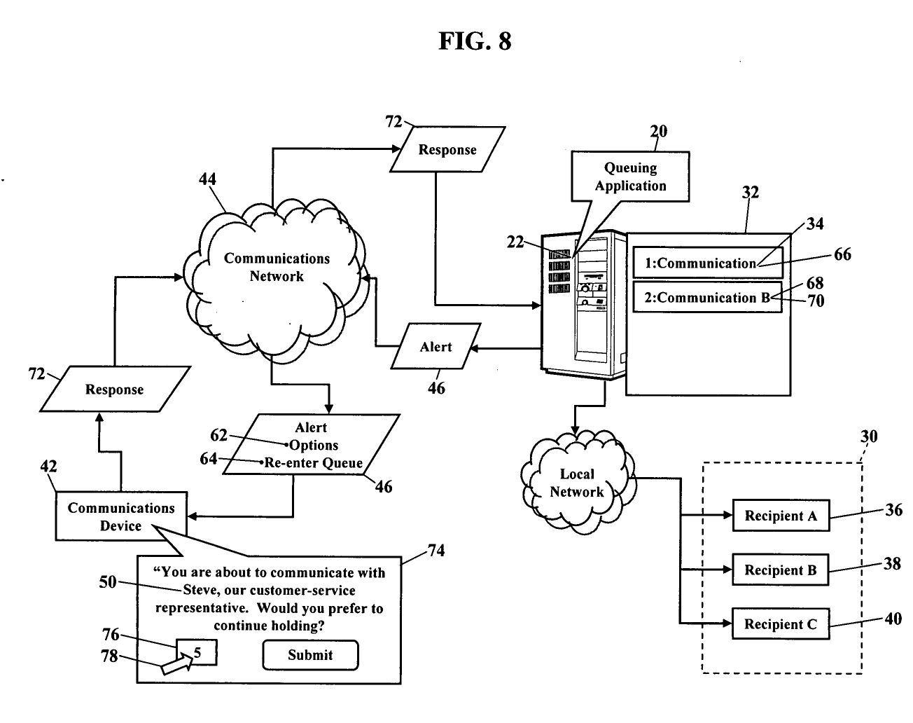

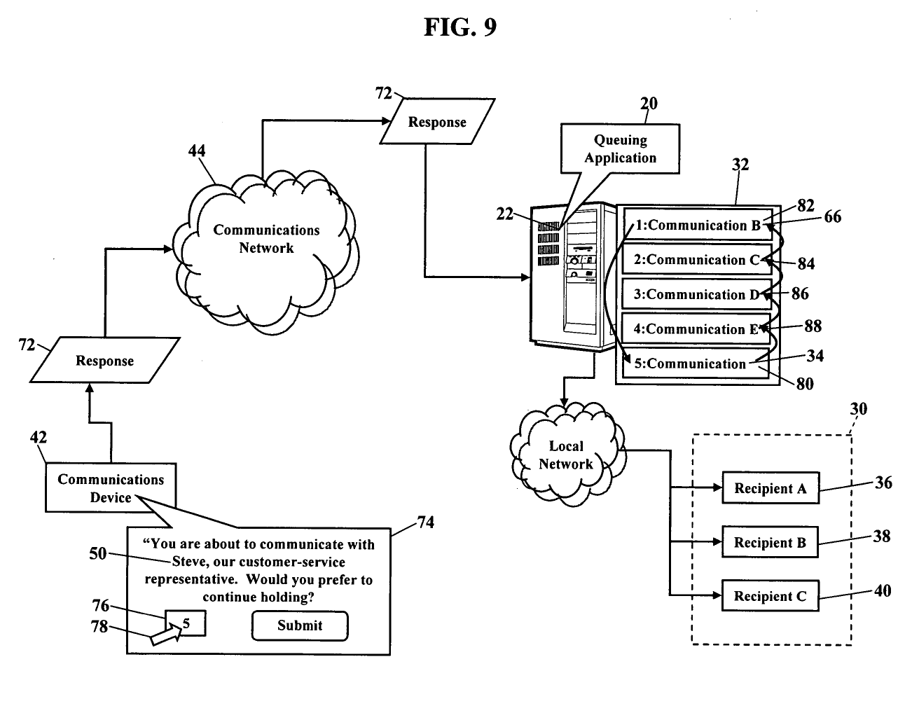

FIGS. 8 and 9 are schematics illustrating another swapping procedure, according to more exemplary embodiments. When the sender's communication 34 sequences to the first position 66 in the queue 32, the sender again has the option to re-enter the queue 32 and to wait an additional time before communicating with the recipient. Here, however, the sender selects their desired additional wait time. FIG. 8, again, illustrates that the sender's communication 34 has sequenced to a top of the queue 32 and occupies the first position 66. The queuing application 20 sends the alert 46, and the alert 46 includes the option 64 to re-enter the queue 32. Here, however, the alert 46 also allows the sender to specify their desired additional wait time. The alert 46 causes the sender's communications device 42 to visually and/or audibly present a prompt 74. Although the prompt 74 may be an audible notification (such as a voice message), FIG. 8, for clarity, illustrates the alert 46 as a graphical notification, such as a “pop-up” window on a display screen or monitor. This prompt 74 provides the name 50 of the next-available recipient. The prompt 74 also asks whether the sender wishes to obtain more wait time. If the sender agrees to accept more wait time (e.g., re-enter the queue 32), then the sender responds by specifying a desired amount of additional wait time. If the prompt 74 was an audible prompt, perhaps the sender pushes a key on a keypad of the communications device 42 to select additional wait time (such as pushing the “5” key to indicate 5 minutes). Voice recognition could also be used to recognize spoken commands. When the prompt 74 is graphical, the prompt 74 may include an entry field 76 in which the sender enters a wait time. After the sender places a cursor 78 in the entry field 76 and enters a time, the sender's communications device 42 sends the response 72 via the communications network 44. The queuing application 20 receives the response 72 and defers the sender's communication 34, according to the sender's desired wait time.

The queuing application 20 may re-order the queue 32. When the sender's response 72 requests additional wait time, the queuing application 20 may use several different methods of providing the sender's additional wait time. Suppose the sender wishes to wait an additional five (5) minutes. The sender enters “5” in the entry field 76 and sends the response 72 (such as by clicking “Submit”). When the queuing application 20 receives the response 72, the queuing application 20 inspects the response 72 and recognizes that the sender requests an additional five minutes of hold time. The queuing application 20 then determines how to re-order the queue 32 to obtain the sender's additional five minute request.

The queuing application 20 may reorder using average wait times. When the queuing application 20 re-orders the queue 32 to obtain the sender's additional hold time request, the queuing application 20 uses the equation below to determine a new position within the queue:

$$New Position = [ \frac{{t}_{requested}}{{t}_{ave}} ] , \qquad ( Equation \#1 )$$

where

t_{requested} is the sender's requested additional wait time (in minutes), and

$$New Position = [ \frac{5 minutes}{1 minute / position} ] = {5}^{th} position .$$

Suppose the average wait time is one minute per position (tₐᵥₑ=1 min/position) in the queue 32. If the sender wishes to wait an additional 5 minutes, then the new position is calculated as

$${t}_{ave} is average wait time ( \frac{minutes}{position in queue} ) .$$

FIG. 9 illustrates a reordering of the queue 32. Because the sender wishes to wait an additional five (5) minutes, the sender's communication 34 should now occupy a fifth position 80 in the queue 32 (as Equation #1 determines). The queuing application 20 removes the sender's communication 34 from the first position 66, advances Communications “B,” “C,” “D,” and “E” (shown respectively as reference numerals 82, 84, 86, and 88), and then inserts, renumbers, or reorders the sender's communication 34 to the fifth position 80 within the queue 32. Based upon the average wait time in the queue 32, the sender's communication 34 moves to the fifth position 80 in order to provide an additional five minutes of wait time.

The queuing application 20 need not accept the sender's desired wait time. The queuing application 20 may have authority to grant, or deny, additional wait time. Suppose a sender requests to wait an additional time, and this additional time exceeds the total wait time for the last position in the queue 32. The queuing application 20 could then return send a reply to the sender's communications device 42, and this reply denies the additional wait time. The reply could even include a statement explaining that the sender's requested additional wait time exceeds the expected time in the queue, so the sender must choose a smaller wait time. The sender would then resubmit the response 72 with a smaller wait time in the entry field 76.

The queuing application 20 may also ignore a request for more wait time. The queuing application 20 may be configured to never permit an available recipient to sit idle. When an attendant or agent (e.g., the recipient 30) is currently available to receive a communication, the queuing application 20 may deny or ignore a sender's request for additional wait time. The queuing application 20 may be configured to seldom permit a recipient to be simultaneously “available” and “idle” when senders are holding in the queue 32. If a sender requests additional time, and this request would result in an idle recipient-attendant, then the queuing application 20 may deny or ignore the sender's request.

The alert 42 may also include other options. When the queuing application 20 sends the alert 46 to the sender's communications device 42, as earlier explained, the alert 46 may include one or more of the options 62. These options 62 allow the sender to control future actions taken by the queuing application 20. One such option, for example, may include parallel communications. Suppose recipients 30 are permitted to “multi-task.” That is, perhaps some experienced recipients are permitted to conduct a voice communication with a caller and, simultaneously, conduct one or more text-based conversations (e.g., email, page, or instant message) with other senders. These experienced recipients may then accept two, or even more, queued communications to reduce wait times. So, while the recipient may conduct a voice call, the recipient may also textually converse with others in the queue 32. These simultaneous text-based communications could be used to obtain preliminary information, such as name, account number, and contact information. If the queued communication is an electronic message (e.g., email, text message, page, or fax), the recipient 30 could, of course, completely resolve the sender's issue while simultaneously conducting a voice call.

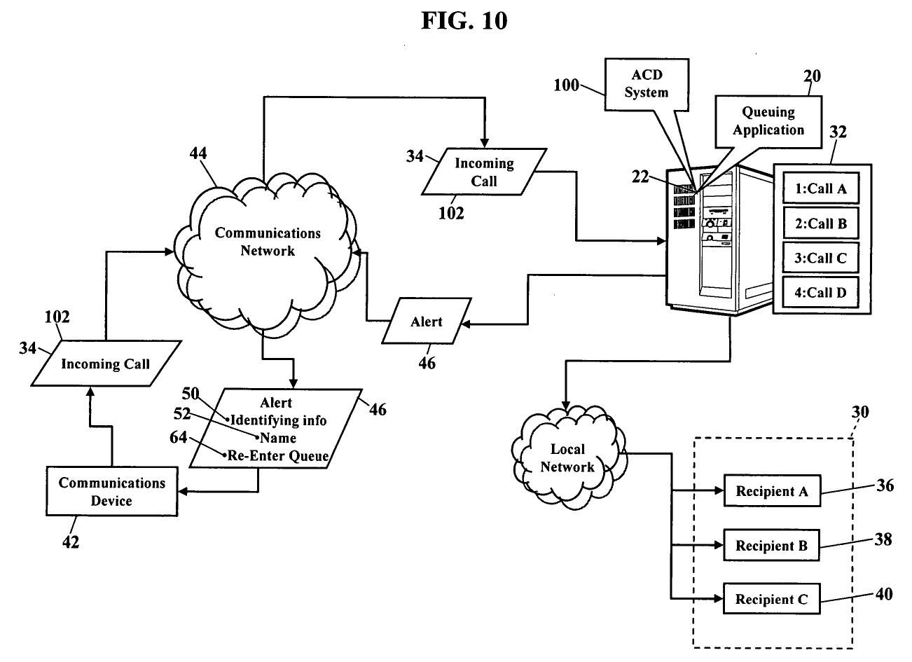

FIG. 10 is a schematic illustrating yet another exemplary embodiment. Here the queuing application 20 is illustrated as queuing voice calls within an Automatic Call Distribution (ACD) system 100. As those of ordinary skill in the art understand, the Automatic Call Distribution system 100 is a software application that responds to callers with a voice menu. The Automatic Call Distribution system 100 queues calls in the queue and connects the calls to attendants. The queuing application 20 may be a stand alone software application, or the queuing application 20 may be a separate module or program that is called when needed. Whatever the construction, when callers need to speak with an attendant, the queuing application 20 provides a holding, queuing function. Because Automatic Call Distribution systems are well-known, this patent will not provide a further explanation.

Here the queuing application 20 queues voice calls. That is, the communication 34 is an incoming voice call 102 (e.g., a POTS call or a VoIP call) received from the caller's communications device 42 (perhaps a telephone, an IP telephony device, a computer, or any processor-controlled device). When the number of incoming voice calls exceeds the number of available attendants-recipients 30, the queuing application 20 places the voice call 102 into the queue 32. As attendants become available to receive the queued calls, the queuing application 20 sequences the calls waiting in the queue 32. At any time prior to removing the voice call 102 from the queue 32, the caller is provided with the recipient's identifying information 50 (such as the name 52) that will receive the voice call 102. The queuing application 20, as earlier explained, return communicates the alert 46 to the caller's communications device 42. The alert 46 includes the identifying information 50, informing the caller of the name 50 of the attendant-recipient. The alert 46 may also include the option 64 to re-enter the queue 32, as above explained.

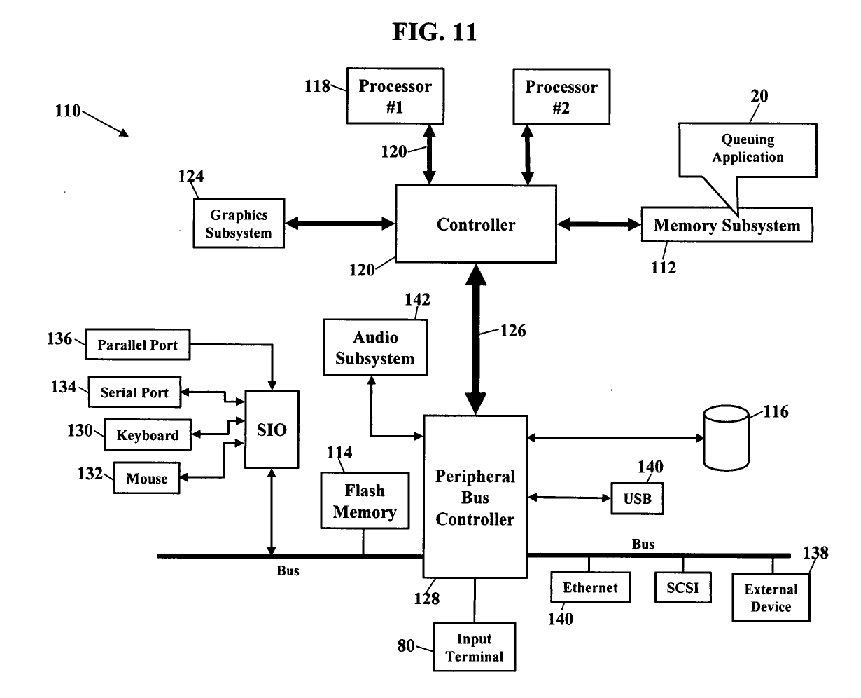

FIG. 11 depicts another possible operating environment for the exemplary embodiments. FIG. 11 is a block diagram showing the queuing application 20 residing in a computer system 110 (such as the communications device 24 and/or computer server 26 shown in FIGS. 1-10). FIG. 11, however, may also represent a block diagram of any computer, any communications device (such as that shown as reference numeral 42 in FIGS. 1-10), or processor-controlled device. The queuing application 20 operates within a system memory device. The queuing application 20, for example, is shown residing in a memory subsystem 112. The queuing application 20, however, could also reside in flash memory 114 or peripheral storage device 116. The computer system 110 also has one or more central processors 118 executing an operating system. The operating system, as is well known, has a set of instructions that control the internal functions of the computer system 110. A system bus 120 communicates signals, such as data signals, control signals, and address signals, between the central processor 118 and a system controller 122 (typically called a “Northbridge”). The system controller 122 provides a bridging function between the one or more central processors 118, a graphics subsystem 124, the memory subsystem 112, and a PCI (Peripheral Controller Interface) bus 126. The PCI bus 126 is controlled by a Peripheral Bus Controller 128. The Peripheral Bus Controller 128 (typically called a “Southbridge”) is an integrated circuit that serves as an input/output hub for various peripheral ports. These peripheral ports could include, for example, a keyboard port 130, a mouse port 132, a serial port 134, and/or a parallel port 136 for a video display unit, one or more external device ports 138, and networking ports 140 (such as USB or Ethernet). The Peripheral Bus Controller 128 could also include an audio subsystem 142. Those of ordinary skill in the art understand that the program, processes, methods, and systems described herein are not limited to any particular computer system or computer hardware.

One example of the central processor 118 is a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), and Transmeta Corp. (3940 Freedom Circle, Santa Clara, Calif. 95054, www.transmeta.com). Those skilled in the art further understand that the program, processes, methods, and systems described herein are not limited to any particular manufacturer's central processor.

According to an exemplary embodiment, the WINDOWS® (WINDOWS® is a registered trademark of Microsoft Corporation, One Microsoft Way, Redmond Wash. 98052-6399, 425.882.8080, www.Microsoft.com) operating system may be used. Other operating systems, however, are also suitable. Such other operating systems would include the UNIX® operating system (UNIX® is a registered trademark of the Open Source Group, www.opensource.org), the UNIX-based Linux operating system, WINDOWS NT®, and Mac® OS (Mac® is a registered trademark of Apple Computer, Inc., 1 Infinite Loop, Cupertino, Calif. 95014, 408.996.1010, www.apple.com). Those of ordinary skill in the art again understand that the program, processes, methods, and systems described herein are not limited to any particular operating system.

The system memory device (shown as memory subsystem 112, flash memory 114, or peripheral storage device 116) may also contain an application program. The application program cooperates with the operating system and with a video display unit (via the serial port 134 and/or the parallel port 136) to provide a Graphical User Interface (GUI). The Graphical User Interface typically includes a combination of signals communicated along the keyboard port 130 and the mouse port 132. The Graphical User Interface provides a convenient visual and/or audible interface with a user of the computer system 110.

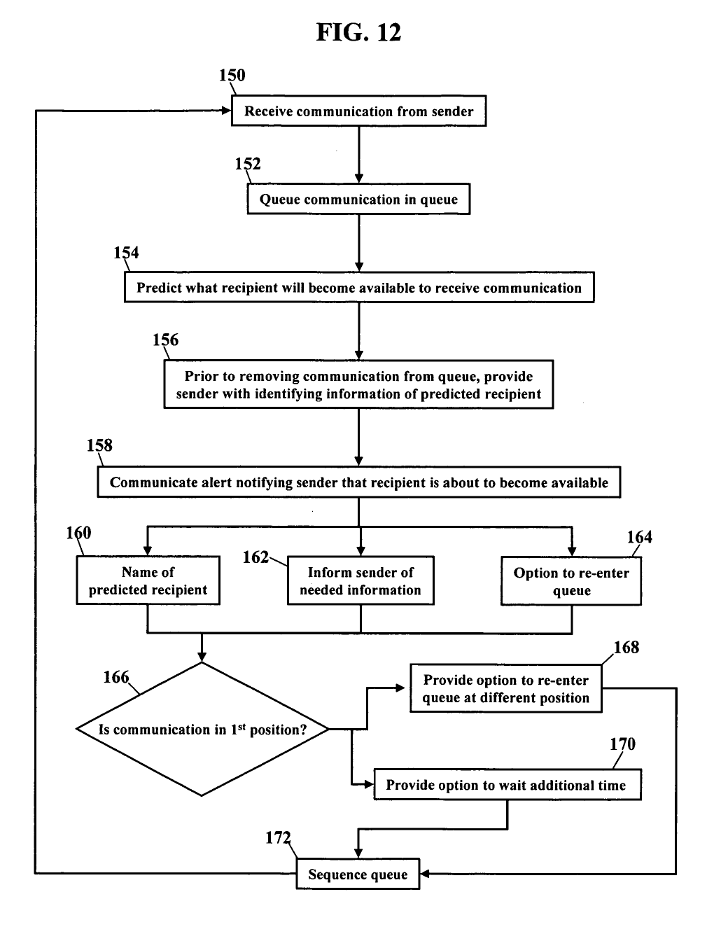

FIG. 12 is a flowchart illustrating a method of managing communications, according to an exemplary embodiment. A communication is received from a sender (Block 150). The communication is queued in a queue (Block 152). A prediction is made as to what recipient will become available to receive the communication (Block 154). Prior to (or contemporaneously with) removing the communication from the queue, the sender of the communication is provided with identifying information of the predicted recipient to whom the communication will be communicated (Block 156). An alert is communicated to the sender, notifying the sender that the recipient is about to become available (Block 158). The alert includes the name of the predicted recipient (Block 160). The alert may also inform the sender of information that will be needed by the recipient (Block 162). The alert may include an option to re-enter the queue (Block 164). When the communication sequences to a first position in the queue (Block 166), the sender may have an option to re-enter the queue at a different position (Block 168). The sender may also have an option to wait an additional time before communicating with the recipient (Block 170). The queue is sequenced (Block 172) and another communication is received (Block 150).

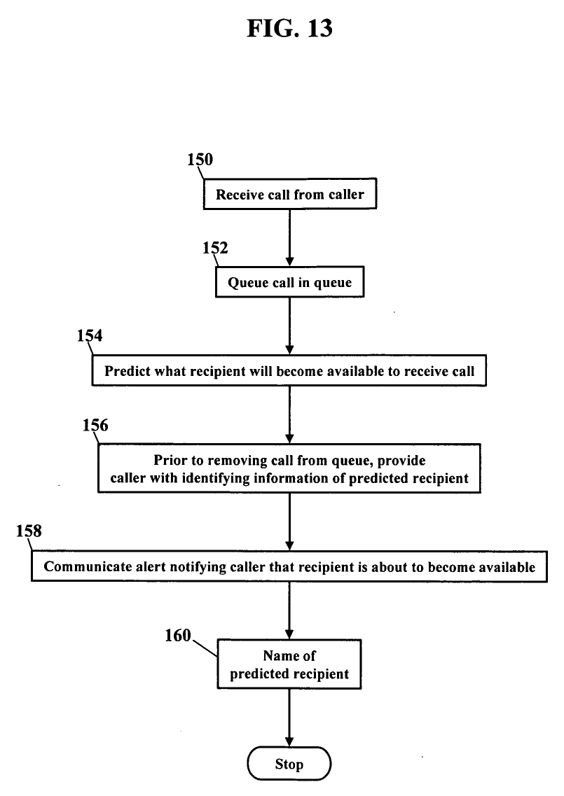

FIG. 13 is another flowchart illustrating another method of managing communications, according to another exemplary embodiment. A call is received from a caller (Block 174). The call is queued in a queue (Block 176). A prediction is made as to what recipient will become available to receive the call (Block 178). Prior to (or contemporaneously with, e.g., depending on how long it takes the call to move from the queue to the recipient) removing the call from the queue, the caller is provided with identifying information of the predicted recipient (Block 180). An alert is communicated to the caller, notifying the caller that the recipient is about to become available (Block 182). The alert includes the name of the predicted recipient (Block 184).

The queuing application (shown as reference numeral 20 in FIGS. 1-11) may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the exemplary embodiments, allow the calendaring application to be easily disseminated. A computer program product comprises the queuing application stored on the computer-readable medium. The queuing application comprises computer-readable or computer-implemented instructions/code for managing communications.

The queuing application may be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol mobile phone, or a wireless pager. Those of ordinary skill in the art will recognize that this solution applies to addressing schemes that may be developed in the future.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

What is claimed is:

1. A method of managing communications, comprising:
receiving a communication from a sender;
queuing the communication in a queue; and
prior to removing the communication from the queue, providing the sender with information related to a recipient to whom the communication will be communicated.

2. A method according to claim 1, further comprising predicting what recipient will become available to receive the communication, and providing that predicted recipient's identifying information to the sender.

3. A method according to claim 1, further comprising communicating an alert to the sender, the alert notifying the sender that the recipient is about to become available, the alert comprising the name of the recipient.

4. A method according to claim 1, further comprising communicating an alert to the sender, the alert informing the sender of information that will be needed by the recipient.

5. A method according to claim 1, further comprising providing the sender an option to re-enter the queue, such that when the communication sequences to a first position in the queue, the sender has the option to re-enter the queue at a different position.

6. A method according to claim 1, further comprising providing the sender an option to re-enter the queue, such that when the communication sequences to a first position in the queue, the sender has the option to wait an additional time before communicating with the recipient.

7. A method according to claim 1, wherein the communication is an incoming call received from a caller, the call is queued in the queue, the queue is sequenced, and, prior to removing the call from the queue, the caller is provided with a name of the recipient to whom the call will be communicated.

8. A system, comprising:
a queuing application stored in memory; and
a processor communicating with the memory,
the processor receiving a communication from a sender and queuing the communication in a queue, and, prior to removing the communication from the queue, the processor provides the sender with identifying information of a recipient to whom the communication will be communicated.

9. A system according to claim 8, wherein the queuing application predicts what recipient will become available to receive the communication, and the queuing application communicates that predicted recipient's identifying information to the sender.

10. A system according to claim 8, wherein the queuing application further communicates an alert to the sender, the alert notifying the sender that the recipient is about to become available, the alert comprising the name of the recipient.

11. A system according to claim 8, wherein the queuing application further communicates an alert to the sender, the alert informing the sender of information that will be needed by the recipient.

12. A system according to claim 8, wherein the queuing application further provides the sender an option to re-enter the queue, such that when the communication sequences to a first position in the queue, the sender has the option to re-enter the queue at a different position.

13. A system according to claim 8, wherein the queuing application further provides the sender an option to re-enter the queue, such that when the communication sequences to a first position in the queue, the sender has the option to wait an additional time before communicating with the recipient.

14. A system according to claim 8, wherein the communication is an incoming call received from a caller, the call is queued in the queue, the queue is sequenced, and, prior to removing the call from the queue, the caller is provided a name of the recipient to whom the call will be communicated.

15. A computer program product comprising computer-readable instructions for performing the steps:
receiving a communication from a sender;
queuing the communication in a queue; and
prior to removing the communication from the queue, providing the sender identifying information of a recipient to whom the communication will be communicated.

16. A computer program product according to claim 15, further comprising instructions for predicting what recipient will become available to receive the communication, and providing that predicted recipient's identifying information to the sender.

17. A computer program product according to claim 15, further comprising instructions for communicating an alert to the sender, the alert notifying the sender that the recipient is about to become available, the alert comprising the name of the recipient.

18. A computer program product according to claim 15, further comprising instructions for communicating an alert to the sender, the alert informing the sender of information that will be needed by the recipient.

19. A computer program product according to claim 15, further comprising instructions for at least one of:
i) providing the sender an option to re-enter the queue, such that when the communication sequences to a first position in the queue, the sender has the option to re-enter the queue at a different position; and
ii) providing the sender an option to re-enter the queue, such that when the communication sequences to a first position in the queue, the sender has the option to wait an additional time before communicating with the recipient.

20. A computer program product according to claim 15, wherein the communication is an incoming call received from a caller, the call is queued in the queue, the queue is sequenced, and, prior to removing the call from the queue, the caller is provided a name of the recipient to whom the call will be communicated.
